(19) United States
(12) Patent Application Publication
(10) Pub. No.: US 2024/0202746 A1
(43) Pub. Date: Jun. 20, 2024

(54) METHODS AND SYSTEMS FOR HIGH EFFICIENCY LOW ENERGY DATA RECEIPT AND PROCESSING

(71) Applicant: Dalrada Financial Corporation, Escondido, CA (US)

(72) Inventor: Nicola DiCicco, San Marcos, CA (US)

(21) Appl. No.: 18/534,548

(22) Filed: Dec. 8, 2023

Related U.S. Application Data
(60) Provisional application No. 63/431,210, filed on Dec. 8, 2022.

(51) Int. Cl. G06Q 30/0201

(52) U.S. Cl. CPC G06Q 30/0201

(57) ABSTRACT

A data and energy efficient model for use in low energy devices that can be enhanced with advanced compression and decompression data analysis in order to do more with less so to speak. Mechanisms for taking a static image of theoretical infinite size and compress it down to an extremely small size. The issue isn't with compression however, rather it is the decompression. The decompression is dependent on how much information is being compressed and the decompression algorithm being used, which can be customized for any desirable structure-type. For dynamic data that builds upon itself, for instance one image after another image at set frequencies, this can work extremely well if the decompression algorithm is brought to specification for the necessary requirements.

### CROSS-REFERENCE TO RELATED PATENT APPLICATIONS

This application claims priority to provisional U.S. Patent Application Ser. No. 63/431,210, filed on Dec. 8, 2022, entitled “Methods and Systems for High Efficiency Low Energy Data Receipt and Processing” and is hereby incorporated herein by reference in its entirety for all purposes.

### BACKGROUND OF THE INVENTION

### Field of the Invention

The present invention generally relates to generating a more efficient control of data storage which allows for greater capacity for a local device to permit calculations and more specifically to the implementation of high efficiency data calculation, compression, analysis, and retrieval techniques in consumer applications in such a way as to increase the applications ability to provide better utility to the consumer in a more efficient way.

### Background Information

Currently there are opportunities to collect growing amounts of data with improvements in sensor and other data measuring technologies, however, the amount of data that can be measured, retrieved, processed, and utilized is limited to energy usage, storage space and speed of transfer and analysis constraints.

The present invention overcomes the existing limitations by creating a more robust and efficient system for the collection and management of large amounts of information through the use of enhanced computing and data manipulation techniques including improved high efficiency algorithms and transfer techniques and software that enable the production of more energy efficient products and systems, combined with real-time monitoring and adjustment capabilities.

### SUMMARY OF THE INVENTION

The embodiments of the present invention generally relate to systems and methods for increasing the efficiency and management of large data inputs and more specifically to enhanced algorithm and software techniques and products which greatly improve measuring, retrieving, processing, and utilizing data information in a highly efficient energy, speed, and storage manner to yield better products for the consumer.

When working with large amounts of data the computing power and energy used to run such data transformation often becomes the rate limiting step. Through the use of novel algorithms calibrated with software to rapidly harvest, compress, decompress, interpret and store or manage large volumes of data, embodiments of the present invention allow for the creation of a metaverse platform that can interact in real-time with functioning machinery to calculate next steps and to manage the efficiency of processes with less energy drain in calculation and storage and less required computing power. This is particularly useful in a model wherein the energy efficiency and storage is limited as in wearable disposables for health maintenance purposes.

Additional embodiments include the application of a metaverse relationship to the data manipulation which allows a digital twin with a greater power source in a distant location to process and make more complex data analysis decisions and input back to the original source in real time. The enhanced compression, and decompression techniques allow for a more efficient transfer and return of information to further enhance the efficiencies of the system. This data compression technique could also allow for the editing of and adjustment of the original data with minimal reconfiguration and pave the way for innovative compression techniques for the foreseeable future. Imagine cloud computing that stores, in near real-time, the entirety of what you've enabled to be stored into the cloud at a fraction of the data storage required today. The largest limiting step would be the required decompression algorithm configuration and the method in which one would want to utilize this information. More specifically though, this format can be structured in something akin to a lattice structure which allows for specific pin-pointing of exact points in the storage-structure, further allowing for specific portions to be grabbed whilst leaving the remaining data, largely, if not entirety untouched.

### DETAILED DESCRIPTION OF THE INVENTION

### Introduction

Although the current methods and systems for high efficiency low energy data receipt and processing can be applied in almost any high computing and data analysis environment, a non-limiting example of the utilization of the methods and systems can be applied to a continuous glucose monitor (CGM) combined with an insulin pump which is generally regarded currently as the best standard of care for a type-1 diabetic.

A limiting factor in progressing this technology is the cost of data storage and usage within the devices themselves and the aggregate data stored in the cloud. Having access to 2 weeks on the device would allow a patient to see their relative trends for the immediate past, i.e., past 14 days. This is currently unavailable and is difficult for a patient to see and interpret without viewing on a webpage off the local device for example. This is inconvenient to a patient and a patient may not even take the time to bother after some time due to the burden and lack of convenience.

Every 5 minutes the CGM data is “recorded”, and a blood glucose level is saved. The CGM data is then sent to the insulin pump where it is displayed. It shows data for up to 24 hours on the pump itself. In the cloud the data is stored for a few months.

One method to save this data is an additive method; store the digital root of the data, a set of information to allow it to be decompressed back, and a proper algorithm to do so.

This set of information required to break it down could be stored daily and again added day by day to get another set of information for decompression to be stored as efficiently as possible.

Using the embodied 1-9 algorithm, a more efficient method can be utilized for advanced medical technologies using multitudes of data to make cutting edge predictions to utilize said data.

Currently the glucose meters are limited into how much data they can process and or store. Generally, a current receiver only holds about 30 days' worth of data, so uploading once a month is recommended to save all patient data. For insulin pumps the current goals with the current techniques strive for at least 90 days of data can be viewed in History. Additionally, the current every 5 minute or so measurements only include one or two physiological parameters. As we evolve the sensing to take more frequent measurements of more physiological parameters there is a strain on the energy and computing capabilities of the current devices. Thus, improvements in the ability and efficiencies to measure, compute and analyze the physiological data to return and make accurate medical treatment decisions will greatly improve patient care and decrease the incidences of emergency services or issues regarding non-compliance and possible diabetic episodes at least in the CGM model.

In addition, utilizing this algorithm, so long as the data is appropriately time-stamped, data from differing sources can be combined into a single dataset and be utilized in unison, i.e. combining data from an insulin pump and a CGM to allow for combined data utilizing the same exact/very nearly identical data storage cost.

The contemplated non-limiting example is as follows:

Highly efficient software and sensors capable of monitoring and measuring physiological parameters such as blood glucose levels embodied in the present invention can take more frequent measurements and process other physiologically relevant parameters for longer periods of time. These readings can be efficiently compressed decreasing energy usage of the measuring device, and send information used to calculate physiological best practices for health maintenance from more sensing screens or in a panel approach that can be reviewed in the cloud and/or with a digital twin that combines higher computing capabilities to signal information to the lower computing piece. previous systems can be used to interact with software platforms in the metaverse to create a secure and traceable source medical record information technology.

The system may comprise a generally disposable lower storage and technology wearable such as a glucose pump related sensor that has the capability of receiving large amounts of physiological information from the treated subject. The wearable device can then efficiently retrieve and condense the data that may be sent or viewable by a digital twin component in the metaverse. The digital twin component may have a larger capacity for storage and data manipulation and may interact with the data through decompression, analysis, comparison to existing data and/or stored data and recompress and send in an efficient compressed packet with instructions for the wearable device to efficiently operate based on the analysis. In this example, the most likely instruction would be to disperse a chemical to control the patients physiological blood sugar in to an optimal range. And continue to disperse more (most likely insulin) as needed to achieve the desired physiological parameters.

A common understanding in statistics is that the greater the number of samples, the more likely you are to get an accurate reflection (the law of large numbers). Based on the current efficiencies of the insulin pumps currently on the market, samples are typically taken every 5-10 minutes or so, and only displayed for up to 24 hours on the device itself, or up to 3 months on the high-side when viewed within a mobile app using a cloud environment. The embodiments of the present invention allow the rapid and almost continuous testing of parameters in a disposable wearable device.

Metaverse related digital twin technology enables the monitoring device to monitor all of the parameters in real-time remotely. Additionally, the technology may enable the CGM to adjust settings and systems within the system equipment to either increase efficiencies, monitor, or correct inefficient systems, or bypass sensors that have become damaged. The technology enables a CGM to adjust detection times, pump disbursements, detect various physiological levels and be cognizant of all aspects of the system proactively and in real-time before a dangerous high peak or valley occurs in a patient's blood sugar management.

The embodied digital twin is a virtual version of the real-world device. The digital twin of the device on a person allows the user to have full access to all of the information in the system which may be stored in an alternate higher-powered device. A metaverse of the entire physiological parameters and sensors is created and a digital twin of the infrastructure is created to enable full review and analysis of the system at all times without the need to analyze and perform the computations on the person.

### Metaverse Component

An embodied CGM employs a web 3.0 solution to create metaverse aspects for the CGM. The metaverse creates a digital twin of the device and accompanying infrastructure equipment. Additionally, the metaverse-enabled technology has the ability to create health related crypto assets which may be in the form of company specific tokens or more broadly used NFTs that are awarded by the insurance companies for providing healthier maintenance of their diabetes as measured by the continuous monitoring and data analysis achievable through these methods and systems. Because studies have shown that proper management of the peaks and valleys of the diabetic patient leads to better long-term health of the patient and less long-term health deficits associated with diabetes. The insurance companies are incentivized to reward this behavior in that it is directly attributable to better health and less costs to the insurance company. The insurance company can directly manage how much the employee has done to reward their help and compensate them with the created digital assets such as NFTs or other tangible and intangible currencies. Providing patients access to more data on their local device, combined with incentivization via ownership of said data via an award's program that can be converted into either fiat, cryptocurrency, or reward conversions upon appropriate review of regulatory and financial rules and regulations should improve patient compliance through improved awareness to the patient and incentivizing participation through what is analogous to gamification of maintaining a chronic illness or other ailment.

Each embodied utilization device may have a digital twin to monitor and maximize performance while allowing for an energy conserving system at site of use (such as in a worn disposable unit in CGM applications).

A non-limiting example of a presently embodied algorithm is included as follows:

The 1-9 algorithm shown above has the following properties:

Note: 9 can have [0,9],[9,9], or [#,9] # being the number/9; i.e. 27/9=3(#). Or 36/9=4(#), etc.

This will yield [#,9]

The modulus of 27 using 9 is 0. This will yield [0,9]

The 9 comes from taking 0.99999(9) into consideration and will yield [9,9]

This only occurs from the number 9. All other numbers do not do this. Only [0,9] and [9,9] described in the image because the # when dividing by 9 is the same for all other numbers, except 9. i.e. the digital root is equal to a digital root/9, 10/9 is 1.1111(1)=1 while 18/9=2 or 1.9999(9) depending on how it is viewed.

The products of the algorithm as they relate to their base numbers shown on a line.

Notice the above image displays the difference between the numbers and the they are equal to 9 when summed at the absolute value, (0/9+9)=9, (1+8)=9, (2+7)=9, (3+6)=9, (4+5)=9.

The effect how numbers related to blood glucose levels.

The image above describes trailing triangles that can have an opposing end with a symmetrical numerical value. These values can be formed into cubes. These cubes will form a rubik's cube type structure. Notice that a digital root is being added to a previous digital root and that there is a separation of 9 between the two when using the 0/9, 1/8,2/7,3/6, or 4/5 pairs.

### Example of Data Circle

The Data Circle shown exemplifires that Any Number (n) data points can be created in a circular form and combined into a single point for each data point, 1->n; thru each digital root of point 1->n can be summoned to a combined digital root.

### Example Zero Enabled Coordinates

### Definitions

Definition of zero 0: The number zero, 0 is a place holder. There is no zero that exists in that it is imaginary. There is nothing that can come from nothing, everything that we know today has come from some precursor of something before that was in another form. Thus, the definition of zero for the context of this application is an imaginary concept, and not a true, realizable phenomena. If something does become nothing, the energy was transformed from one place to another but that energy is not 0, merely in a new form.

Definition 1: The numbers 1,2,3,4,5,6,7,8 and 9 are the base case numbers. There are the only numbers that reflect the reality of every potential outcome.

Definition 2: The digital root is the sum of the digits within a number, reduced to the single digit root of 1-9. For example, 147=1+4+7=12 which equals 1+2=3. Or alternatively, 147=1+4=5, 5+7=12, which 1+2=3. The sequence in which the numbers are added, or perhaps subtracted, is of no consequence so far as this phenomenon is present.

Definition 3: A Modulus; The modulus is the numbering system utilized in which to base the amount remaining, this remainder is termed the mod or modulus of said number.

For example, Modulus 1-, if a number is 11 and you want Modulus 10, the answer is 10+1. 10 goes into 11 one whole time and have a remainder of 1. Using Mod(ulus) 10 of number 11 is therefore 1.

Definition 4 Additive Digital Root: The additive digital root is the summation of one digital root, combined with another digital root, to create a new digital root representing both of the previous 2 digital roots combined.

### EXAMPLE

Digital root A: 147=1+4+7=12=1+2=3

Digital root B: 89234=8+9+2+3+4=26=2+6=8

(Digital root A+Digital root B)=3+8=11, =1+1=2.

Definition 5: Digital Root Memory: The digital roots can be chained together in a never-ending sequence and able to maintain the simplicity of a single digit, whilst maintaining the previous ‘memory’ of the original configuration if a proper decompression algorithm is present.

Definition 6: The 9 by 9 by 9 triangle: This triangle is a special triangle that all data, when framed as explained will have properties that add to the sum of 9,9,9 for all 3 sides. There is a 90 degree base with two 45 degree angles on the sides. This is an isosceles triangle from the technical standpoint of traditional math, but has equilateral sums from the digital root standpoint.

A special note must be made for this because the absolute value of the differences must be applied to achieve the 9×9×9 triangle.

Definition 7 Digital Root Trailing: Taking any number, it can be placed to sequence within specific targeted base roots, if desired. This is termed digital root trailing because the trail to be followed is set for the digital root to find the path forward.

### EXAMPLE

Digital Root Trailing using base number 5. The sum of the trailing digits digital root must add to 5, then the sequence of digital root calculations is started anew, leaving the residing digital root in its place. There is a summary at the end of this example:

The number pi, with the first 100 digits.

3.1415-926535897932-38462-6433832795-0288841-9716-93993751058-20974944-592307816406286208998628-0348253421-1706-79 . . .

3+1+4+1+5=14=1+4=5

Continuing, leaving the 5 unmodified and untouched, Beginning at 3.1415 . . . 9

9+2+6+5+3+5+8+9+7+9+3+2=68 which =14=1+4=5.

Continuing leaving the previous 5s in place.

3+8+6+4+2=23=2+3=5.

Continuing leaving the previous 5s in place.

6+4+3+3+8+3+2+7+9+5=50=5+0=5

Continuing leaving the previous 5s in place.

0+2+8+8+4+1=23=2+3=5

Continuing leaving the previous 5s in place.

9+7+1+6=23=2+3=5.

Continuing leaving the previous 5s in place.

9+3+9+9+3+7+5+1+0+5+8=59=5+9=14=1+4=5

Continuing leaving the previous 5s in place.

2+0+9+7+4+9+4+4+5+9+2+3+0+7+8+1+6+4+0+6+2+8+6+2+0+8+9+9+8+6+2+8=158=1+5+8=14=5.

Continuing leaving the previous 5s in place.

0+3+4+8+2+5+3+4+2+1=32=3+2=5.

Continuing leaving the previous 5s in place.

1+7+0+6=14=1+4=5.

Continuing leaving the previous 5s in place.

7+9 . . . (digital root=16=1+6=7. Stopped at 100^{th} digit of pi).

### Explanation

The digits are added in sequential order until the sum of the digital root achieve a desired base number, in this case 5. After 5 is achieved, the digital root counting starts again and the 5 is left in its place of the previous digits. I placed a (-) as a separator designator for the base number when the digital root achieved is 5. In essence the entirety of pi can be sequenced to represent 0.55555555555555555(5) as long as one would like to continue.

This can be done with any base number 1-9 and will create a number in which pi can be framed from different perspectives than before.

Definition 8:

The Digital Root Divisibility by 9 Rule:

When dividing any number by 9, the digital root will present in a repetitive sequence as, the decimal repeat.

For instance:

The digital root of 111=1+1+1=3.

If one divides the un-rooted number, 111 by 9. The repeating decimal will be 3.

111/9=12.333333(3). The repeating sequence is true for all numbers, including 9.

9 is a special case however, because traditionally in math we round 0.999 to a whole number so anything divisible will be a clean whole number, but it can be viewed as a 0.99999(1).

For instance 99/9 can be equal to 10.99999(9) in which case this rule is obeyed, or it can equal 11 in which case the rule is not obeyed.

If viewed in this light, all numbers follow the sequence of repeating digits when applied as described herein. This can cause a disagreement in how the numbers are interpreted though and there a multitude of ways that 9 can be interpreted.

Definition 9: The Mod and Digital Root Rule of 9:

The mod and digital root rule of 9. [mod/digital root]

Herein is a description of numbers 1-9 with each number having the number 9 added thereafter in a sequence, for as long as desired, into infinity if so desired.

+9->>>>>>>>>[Mod 9, Digital Root]

1->10->19->28->37 . . . [1,1]

2->11->20->29->38 . . . [2,2]

3->12->21->30->39 . . . [3,3]

4->13->22->31->40 . . . [4,4]

5->14->23->32->41 . . . [5,5]

6->15->24->33->42 . . . [6,6]

7->16->25->34->43 . . . [7,7]

8->17->26->35->44 . . . [8,8]

9->18->27->36->45 . . . [0,9] AND/OR [9,9 (if rule 8 is applied)] this allows for a number to be in multiple states simultaneously and can provide towards quantum.

Finite=has a start and an end.

Infinite=has an unbounded end, start, finish, or both.

Definition 10 Divisibility using 1:

When dividing 1 as the dividend and 1,2,4,5,or 8 as the divisor. The answer is finite.

For example:

1/1=1.0, 1*1−1.0 Finite

½=0.5, 2*0.5=1.0. Finite.

¼=0.25, 0.25*4=1.0. Finite

1/5=0.2*5=1.0. Finite.

1/8=0.125*8=1.0. Finite

When using the numbers 3,6,9 and 7 as divisors the answer is infinite.

1/3=0.3333(3), *3=0.9999(9). Infinite

1/6=0.1666(6), *6=0.9999(9)6. Infinite.

1/9=0.1111(1), 0.111(1)*9=0.9999(9). Infinite.

1/7=0.142857 . . . repeating sequence repeating sequence forever. Infinite.

Note there is no 3, 6, or 9 with 1/7 sequence.

Definition 11:

The DeCoCo (DeCoding Coordinates) Plot:

Combining the traditional cartesian coordinate system with the graphing system embodiments utilize a combination of traditional cartesian plotted data into a new graphing paradigm utilizing the DeCoCo Plot which will plot the Cartesian coordinates onto the new form to create a new graph entirely.

Definition 12: Space-Time Structure

A structure of this numbering system in a 3 dimensional space that is dynamic and conforms to a rubik's cube in an alternating sequence of quarter turns.

When viewing from the birds eye view, there will be only 8 corners viewable.

When viewing from the side -angle, there will be a depth of 3 layers with 2 aligned and 1 offset.

Layers: Top, Middle, Bottom

Top Layer is aligned.

Middle layer is 45 degrees off.

Bottom layer is aligned with the top layer. If the bottom layer is rotated and realigned, there is not noticeable difference from the bird's eye view. However, the number sequence has changed so there is a difference that we cannot directly view.

If each color on the rubik's cube is treated as a number 1-9, slightly offsetting these cubes to the configuration described will create a structure that may resemble space

The incorporated use of triangulation to achieve certain number understandings.

When working with large amounts of data the computing power and energy used to run such data transformation often becomes the rate limiting step. Through the use of novel algorithms calibrated with software to rapidly harvest, compress, decompress, interpret and store or manage large volumes of data, embodiments of the present invention allow for the creation of a metaverse platform that can interact in real-time with functioning machinery to calculate next steps and to manage the efficiency of processes with less energy drain in calculation and storage and less required computing power. This is particularly useful in a model wherein the energy efficiency model is the intent of the application.

Incorporating a specific algorithm that utilizes a schema wherein the mod and the digitized root are equal at all numbers except at nine where there is a binary possibility one of which is a mod and digitized root equal and the other wherein the mod is zero and the digitized root is 9.

Algorithm wherein division check is a number base over 9; with the exception that 9 over 9 equals 1, all others 1-8 base numbers over the same number e.g., 4 over 4, 5 over 5 . . . equals 0.1111 repeating decimal.

The general idea is that any number no matter how large can ultimately be compressed within the algorithm and be compressed to a single number.

What is claimed is:

1. A system for increasing the efficiency and management of large data inputs and more specifically to enhanced algorithm and software techniques and products which greatly improve measuring, retrieving, processing, and utilizing data information in a highly efficient energy, speed, and storage manner to yield better products for the consumer.

2. A method for increasing the efficiency and management of large data inputs and more specifically to enhanced algorithm and software techniques and products which greatly improve measuring, retrieving, processing, and utilizing data information in a highly efficient energy, speed, and storage manner to yield better products for the consumer.
